(19) United States
(12) Patent Application Publication
(10) Pub. No.: US 2017/0036937 A1
(43) Pub. Date: Feb. 9, 2017

(54) METHOD FOR TREATING AQUEOUS SALINE STREAMS

(71) Applicant: Abengoa Water S.L., Sevilla (ES)

(72) Inventors: Mohamed Khayet Souhaimi, Sevilla (ES); María del Carmen Garcia Payo, Sevilla (ES); Hicham El Bakouri, Sevilla (ES); Abel Riaza Frutos, Sevilla (ES); Francisco Javier Bernaola Echevarria, Sevilla (ES)

(21) Appl. No.: 15/305,424

(22) PCT Filed: Dec. 17, 2014
(86) PCT No.: PCT/ES2014/070931

§ 371 Date: Oct. 20, 2016

(30) Foreign Application Priority Data
Apr. 21, 2014 (ES) P201430584

(51) Int. Cl. C02F 9/00; B01D 71/36; B01D 61/36

(52) U.S. Cl. CPC C02F 9/00; B01D 61/364; B01D 71/36; C02F 1/447

(57) ABSTRACT

A method for treating aqueous saline streams, specifically saline effluents, by means of membrane distillation with pre-treatments, in order to remove total calcium hardness and permanent calcium hardness and the presence of sulphates in saline effluents, more specifically in residual brines from desalination plants. The system makes it possible to concentrate brines above 37% by weight, i.e. above the saturation level, which makes it possible to reduce the volume of brine considerably, making it suitable for other industrial uses and producing pure water.

The present invention relates to a method for treating aqueous saline streams, preferably saline effluents and more preferably, saline effluents coming from desalination plants, comprising a chemical treatment of the aqueous stream, particularly for the effluent or brine, followed by a membrane distillation treatment. As such, the invention would fall within the field of water desalination or the treatment of effluents with high salt contents.

### STATE OF THE ART

Membrane technologies are currently the most frequently used types of technology in the desalination field. In this context, reverse osmosis (RO) alone or combined with other membrane processes such as microfiltration (MF), ultrafiltration (UF) and nanofiltration (NF), constitutes the practice most often employed. Nevertheless, RO is not usually used to treat effluents with very high salt contents (above 100 g/L), since the osmotic pressure in this case exceeds 80 bars and the commercial membranes used with this technology only support pressures of between 70 and 85 bars. Applying a pressure of (approximately) 84 bars to 100 g/L of brine would mean the permeate flux is almost zero, for example. In order to make the brine more concentrated and obtain a considerable volume of permeate, it is necessary to work at much higher pressures, which is not possible given the limits of this technology.

As such, membrane distillation (MD) is becoming a very efficient alternative, either alone or combined with RO, amongst other desalination technologies, in terms of increasing water production, whilst minimising the volume of brine as much as possible. Nevertheless, MD is limited in terms of forming and deposing incrustations, which make the concentration process difficult. For example, Mericq et al. [Mericq J., Laborie S., Cabassud C., 2010. Vacuum membrane distillation of seawater reverse osmosis brines. Water Research 44, 5260-5273] have proposed a vacuum membrane distillation system for treating synthetic brine only containing the mineral portion of compounds present in seawater. Starting with brine at a concentration of 50 g/L, they succeeded in attaining a concentration in the order of 300 g/L, with an overall recovery rate of 89%. The study reveals the possibility of removing the incrustations formed during the brine concentration process, by means of washing the membranes with water, since the crystals are only formed at the membrane surface, without completely obstructing the pores.

Moreover, WO2009055377 describes a method for preventing the formation of incrustations and their deposition in thermal desalination processes as a result of membrane distillation, comprising the addition of inert dispersion agents, such as an incrustation prevention composition, into the brine stream or “input stream”.

Nevertheless, the main limitation of MD is the need to prevent the liquid from penetrating the membrane pores. There is a liquid entry pressure (LEP) from which the liquid wets the pores. This pressure depends on the membrane itself, on the type of solution in contact with the membrane and the concentration thereof, as well as its temperature. Other limitations of MD include internal temperature loss produced through the membrane itself (heat transfer by conduction), especially when direct contact membrane distillation (DCMD) is used, and the lack of commercial membranes specifically designed for this process. Furthermore, the concentration of brines above the saturation point of the salts present gives rise to membrane degradation due to the formation of crystals.

Moreover, membrane crystallisation is a technique proposed as an extension of the MD concept [Drioli, E; Criscuoli, A y Curcio, E. (2002) Integrated membrane operations for seawater desalination. Desalination 147, 77-81]. Using this system, solutions concentrated by MD pass through a crystalliser in order to recover salts, which solubility coefficient decreases with temperature. Crystals thus begin to form far away from the surface of the membrane, which reduces the problem of incrustation, improving therefore the permeate fluxes. Moreover, Ji et al. pi X., Curcio E., Al Obaidani S., Di Profio G., Fontananova E., Drioli E., 2010. Membrane distillation-crystallization of seawater reverse osmosis brines. Sep. Purif. Technol. 71, 76-821, used membrane crystallisation using a hollow fiber module, which makes it possible to attain a conversion factor of 88-89%, concentrating brine and maintaining the conductivity of the permeate below 3.5 μS/cm.

As such, it would be necessary to find a suitable method for treating aqueous saline streams or brines, avoiding high energy consumption and/or the obstruction or deterioration of the membranes used in different concentration techniques.

### DESCRIPTION OF THE INVENTION

The present invention relates to a method for treating aqueous saline streams or streams with a high salt content, comprising a chemical treatment for the aqueous stream, in order to remove all calcium hardness and/or permanent calcium hardness, particularly for effluents present in residual brines from desalination plants, followed by a membrane distillation treatment. Salt concentrations of above 37% by weight are obtained through this process, i.e. above the limiting salt saturation concentration level, thus making it possible to reduce the volume of brine considerably in order to facilitate more efficient management, making it suitable for other industrial uses and producing pure water in one single step.

In such cases, depending on the composition of the aqueous stream, the concentrated brine may be used as a raw material for other industrial processes such as chloro-alkali, with the aim of producing caustic soda and chlorine compounds or making the same suitable for the Solvay process, in order to produce sodium carbonate.

The advantages of MD in the desalination or conventional distillation field, and more specifically the advantages of the invention, among others, are as follows:
Due to the absence of liquid transport in MD, species such as ions, macromolecules, colloids and non-volatile solutes, which cannot evaporate and spread through the membrane, are retained in the feed solution, attaining a few degrees of separation greater than 99.9%. As such, solutions with high concentrations of non-volatile solutes, which have high osmotic pressures making impossible to use processes such as RO, may be treated and pure water may be produced in one single step, both simply and quickly;
Lower temperatures than those used in conventional distillation may be employed, since it is not necessary to work at temperatures above the boiling point of the solution to be treated. As such, it is possible to use the residual heat produced in industrial processes and alternative energy sources such as solar or geothermal energy, thus attaining competitive costs owing to the energy savings made as a result of working at lower temperatures;
It may be used to treat wastewaters and separate temperature sensitive compounds (products of great interest in the food industry, for example juice, in which the vitamins degrade as a result of heat, since it may be carried out at very low temperatures (25-30° C.) and at atmospheric pressure). In other technologies performed at high pressures, the energy consumption of the process is higher, thereby influencing the cost of materials to be used, since they must be able to support greater pressures in addition to being able to resist corrosion as a result of the high level of chlorides;
In comparison to conventional distillation systems, MD systems may be much smaller, being more compact and thus occupying less volume;
In the case of MD, very concentrated brines that could not be treated with RO may be treated. As such, with the invention method, salts from the aqueous stream are concentrated, reducing the volume of brines and obtaining high quality (pure) water;
The pores of the membrane do not get as dirty or clogged as in other membrane processes.

A first aspect of the present invention relates to a method for treating aqueous saline streams, comprising the following steps:
a. Chemical treatment of the saline stream at a temperature above the freezing point of the aqueous stream to be treated, in order to remove permanent calcium hardness, temporary calcium hardness and/or to reduce or remove sulphates until a calcium and magnesium concentration of less than 3 ppm and a sulphate concentration of less than 1 g/L are obtained;
b. Separating the salts formed in step (a) and;
c. Concentrating the aqueous stream obtained in the separation stage of step (b) by means of membrane distillation at a temperature below the boiling point of said aqueous stream, where the membrane is a porous, hydrophobic polymeric membrane, preferably being microporous.

In the present invention, “aqueous saline streams” are understood to mean an aqueous stream with conductivity greater than 2500 μS/cm at 25° C., with a total dissolved solids content (TDS) above 0.5 g/L. The streams of water may come from natural water, such as sea water or brackish water or may be industrial or urban water. The method of the present invention makes it possible to treat any kind of aqueous saline streams; however, in a particular embodiment, this stream is a “saline effluent” constituting residual brines, especially from desalination plants, with very high salt concentrations above 40 g/L of TDS and an electrical conductivity greater than 60 mS/cm at 25° C., where the most abundant salt is NaCl, with a concentration over 60% by weight relative to the total dissolved salt content.

In a first step of the method of the present invention, a chemical treatment is applied to the saline stream at a temperature above the freezing point of the aqueous stream to be treated, up to the temperature at which step (c) is carried out, in order to remove permanent calcium hardness, temporary calcium hardness and/or to reduce or remove sulphates.

The chemical treatment applied in the invention method is a chemical treatment that does not require solvents and/or inert dispersion agents, which prevent crystal nucleation or growth and in addition, aims to minimize, as far as possible, the risk of incrustations forming on the membranes used in MD as a result of the potential formation of salts, for example calcium fluoride, calcium phosphate, barium carbonate, strontium carbonate, calcium carbonate, magnesium carbonate, a mixture of magnesium and calcium carbonate, magnesium hydroxide, calcium sulphate at different hydration levels or co-precipitation silica.

“Temporary calcium hardness” and “carbonate calcium hardness” are understood to mean the presence of carbonic species in the aqueous stream to be treated, which may react with the calcium, in order to form calcium carbonate.

“Permanent calcium hardness” or “non-carbonate hardness” is understood to mean the presence of anions, which may react with calcium to form salts that dissolve more easily at high temperatures, i.e. at a temperature that may be comprised between approximately 50° c. and approximately 80° C. This hardness is mainly due to the sulphates and chlorides.

“Total calcium hardness” is understood to mean hardness owing to all of the calcium that may react with any anion to form calcium salts.

In a preferred embodiment, the temperature in step (a) is essentially the same as the temperature of step (c). In the present invention, the word “essentially” is understood to mean that said temperature may differ in an interval of between ±1° C. and 5° C., without any variation of the efficiency and performance of this preferred embodiment of the invention method.

In another preferred embodiment of the invention method, the temperature of step (a) is between 18° C. and 85° C. and more preferably between 25° C. and 75° C. More preferably still, step (a) is carried out at atmospheric pressure (approximately 1 atm.).

The chemical treatment applied in step (a) of the method of the present invention will depend on the salts dissolved in the aqueous saline stream to be treated and the concentration of the same.

In a more preferred embodiment of the present invention, the treatment applied in step (a) consists of adding sodium hydroxide, sodium carbonate or both to the aqueous saline stream, in order to remove the temporary and permanent calcium hardness, i.e. to remove the calcium that may react with the carbonic species present in the aqueous saline stream, in order to form calcium carbonate (CaCO₃), plus the calcium that may react with the sulphates to form gypsum.

When sodium hydroxide and sodium carbonate (NaOH+Na₂CO₃) are added to the aqueous saline stream as part of the treatment applied in step (a), in order to remove temporary and permanent calcium hardness, the following reactions take place:

$$\begin{matrix}2 {Ca}^{2 +} + 2 {HCO}_{3}^{-} + 2 NaOH \to 2 {CaCO}_{3} ( s ) + 2 {Na}^{+} + 2 {H}_{2} O & ( 1 ) \\ {Ca}^{2 +} + [ \frac{{SO}_{4}^{2 -}}{2 {Cl}^{-}} ] + {Na}_{2} {CO}_{3} \to {CaCO}_{3} ( s ) + 2 {Na}^{+} + [ \frac{{SO}_{4}^{2 -}}{2 {Cl}^{-}} ] & ( 2 )\end{matrix}$$

Taking into account the stoichiometry of the previous reactions and the composition of salts in the aqueous saline stream, it is possible to estimate the amount of reactants needed as follows:
Neutralisation of the carbonic acid: NaOH═{H₂CO₃⁻}
Carbonate calcium hardness: NaOH═{HCO₃⁻}+{CO₃²⁻}
Non-carbonate calcium hardness: Na₂CO₃═{Ca²⁺}-2{HCO₃⁻}—{H₂CO₃⁻}—{CO₃²⁻}

In order to simplify the calculations, all concentrations ({ }) are expressed in mg/L of CaCO₃.

In a preferred embodiment, in order to remove the temporary hardness, the stoichiometric amount of NaOH needed to neutralise the acid in the water is used, in order to remove the calcium carbonate hardness, as well as to remove the non-carbonate calcium hardness, the stoichiometric amount of Na₂CO₃ needed is used, the use of excess sodium carbonate being preferable, more preferably between 5-30% and more preferably-, an excess of between 20-30% relative to the stoichiometric amount.

Furthermore, if the sodium hydroxide and/or sodium carbonate treatment takes place at a high temperature, i.e. at a temperature of between 50° C. and 80° C., this treatment may facilitate the removal of the residual calcium carbonate, since the solubility of this crystalline phase reduces with temperature. In a preferred embodiment, the high temperature of step (a) is essentially the same as the temperature of step (c).

As such, when sodium hydroxide is added to the treatment at a high temperature, i.e. at a temperature of between 50° C. and 80° C., the carbonate calcium hardness is removed. This treatment may prove useful for treating aqueous saline streams with a high carbon content and low calcium content. The amount of caustic soda needed to carry out the treatment may be estimated, in the same way as indicated before. In a preferred embodiment, the pH of the system would be between 10 and 10.5, as such improving the efficiency of this treatment.

Furthermore, when sodium carbonate is added to the treatment at a high temperature, i.e. at a temperature of between 50° C. and 80° C., it is possible to remove the permanent calcium hardness. This treatment may prove useful for aqueous saline streams with high alkalinity and a low carbon content. Taking into account the stoichiometry of the reactions, it is possible to estimate the amount of reactant needed to carry out the treatment as indicated above. In order to completely remove the calcium, an excess of sodium carbonate over the stoichiometry would be required, preferably an excess—between 5-30% and more preferably—an excess of 20-30% relative to the stoichiometric amount. The excess amount will depend on the ionic force of the aqueous stream to be treated and the pH of the system.

The optimal conditions for carrying out the chemical treatments of step (a) and subsequent step (b), adding sodium hydroxide, sodium carbonate or both, described above, would be as follows:
Minimum reaction time: 15 min
Preferred reaction time: 30 min
Maximum flocculation time: 15 min
Minimum hydraulic retention time for decantation: 30 min
Preferred hydraulic retention time for decantation: 120 min
Clarified filtration: preferred.

In another preferred embodiment of the invention method, in treatment step (a), calcium salts, selected from calcium chloride and lime or barium salts selected from barium carbonate or barium chloride are added to the aqueous saline stream to be treated, in order to reduce or remove sulphates.

The first calcium salts treatment may prove useful to reduce the sulphate content to concentrations in the order of 1 g/L, whilst the second treatment, with barium salts, may facilitate the almost complete removal of the sulphates.

When the aqueous saline stream to be treated has a high salt content, i.e. a calcium salt or magnesium salt content greater than 40 g/L, and high sulphate concentrations (SO₄²⁻), preferably concentrations of over 2 g/L, this treatment may be carried out by adding calcium in the form of calcium chloride (CaCl₂).

If the aqueous saline stream to be treated is acidic, adding the calcium in the form of lime proves useful, since, despite being difficult to manage, it is competitively priced (3):

SO₄²⁻+Ca²⁺+2H₂O→2CaSO₄(s).2H₂O (3)

The kinetics of the reaction for forming gypsum are very slow, thus meaning that in order to avoid oversaturation and subsequent precipitations, the reaction must be carried out in the presence of a large amount of crystal nuclei.

In a preferred embodiment, the calcium is added in excess relative to the stoichiometric amount, more preferably being an excess of between 10-50% and more preferably, an excess of between 25-50% relative to the stoichiometric amount.

Another alternative for removing the sulphates may consist of using barium salts. In a preferred embodiment, barium chloride (BaCl₂) is used to produce insoluble barium sulphate (BaSO₄), according to the following reactions:

CaSO₄+BaCl₂→BaSO₄(s)+CaCl₂ (4)

Na₂SO₄+BaCl₂→BaSO₄(s)+2NaCl (5)

Despite the fact that this barium salt treatment for removing sulphates is highly efficient, it is relatively costly and proves limiting in that it is not recommended for treating streams of water to subsequently be consumed, as a result of toxic residual barium.

In a preferred embodiment, the stoichiometric amount of barium salts is used to remove almost all of the sulphates.

The optimal conditions for carrying out the chemical treatments described in step (a) and subsequent step (b) using barium salts are similar to the above.

The optimal conditions for reducing the sulphate content with calcium salts are as follows:
Minimum reaction time: 20 min
Preferred reaction time: 40 min
Maximum flocculation time: 15 min
Minimum hydraulic retention time for decantation: 60 min
Preferred hydraulic retention time for decantation: 180 min
Clarified filtration: preferred.

In another preferred embodiment of the invention method, in the treatment applied in step (a), sodium hydroxide, sodium carbonate and barium chloride are added to the aqueous saline stream to be treated, in order to remove both the calcium and the sulphates present in this stream and, as such, to remove the permanent calcium hardness, temporary calcium hardness and/or to reduce or remove sulphates. This treatment is favourable in cases in which the useful life of the membranes used in the previous step (c) is to be extended or when a permeate quality similar to that of distilled water is required. The optimal conditions for carrying out this chemical treatment applied in step (a) and subsequent step (b) would be as follows:
Minimum reaction time: 15 min
Preferred reaction time: 30 min
Maximum flocculation time: 15 min
Minimum hydraulic retention time for decantation: 30 min
Preferred hydraulic retention time for decantation: 120 min
Clarified filtration: preferred.

Once the aqueous saline stream has been treated in step (a), it is important to remove the precipitates formed from the treated stream, in order to prevent crystals from obstructing the membranes used in the subsequent distillation step (c) described in the invention method. The separation step (b) may be carried out by means of any technique known to one skilled in the art, for example by means of decanting and/or filtering systems, not being limited to these techniques.

After the step (b) of separating the salts precipitated in step (a), we proceed to step (c), i.e. the concentration of the aqueous stream obtained in said separation by means of membrane distillation at a temperature below the boiling point of said aqueous stream, wherein the membrane is a porous, hydrophobic polymeric membrane, preferably being microporous.

In another preferred embodiment, the invention method furthermore comprises a purification step (d) for purifying the aqueous stream obtained in step (c) by means of membrane distillation at a temperature below the boiling point of said aqueous stream to be purified, wherein the membrane is a porous hydrophobic polymeric membrane, preferably being microporous.

The temperature at which the membrane distillation is carried out, in both step (c) and (d), is limited in its lower range by the temperature at which the treatment is applied in step (a).

In another, more preferred embodiment, the temperature of step (d) is essentially the same as the temperature of step (a) and the temperature of steps (c) and (d) are more preferably essentially the same as the temperature of step (a). In the present invention, the word “essentially” is understood to mean that said temperature may differ in an interval of between ±1° C. and 5° C., without any variation of the efficiency and performance of this preferred embodiment of the invention method.

In another preferred embodiment of the invention method, the temperature of step (c) and/or of step (d) is between 18° C. and 85° C., more preferably being between 25° C. and 75° C.

The techniques or configurations of the concentration process by means of membrane distillation (MD) proposed in this invention may be selected from: direct contact membrane distillation (DCMD), sweeping gas membrane distillation (SGMD), air gap membrane distillation (AGMD), vacuum membrane distillation (VMD), thermostatic sweeping gas membrane distillation (TSGMD) and liquid gap membrane distillation (LGMD) and extend to any other combined MD configuration.

The term “classic MD configuration” is understood to mean direct contact MD, sweeping gas MD, air gap MD or vacuum MD.

In the present invention, “mixed configurations” are understood to mean the combination of different classic MD configurations in the same module, for example thermostatic sweeping gas membrane distillation (TSGMD) (a variety of sweeping gas and air gap membrane distillation); liquid gap membrane distillation (a variety of air gap membrane distillation and direct contact membrane distillation); direct contact and vacuum membrane distillation (DCVMD) applying a vacuum in the permeate side or sweeping gas at low pressure (VSGMD), using a vacuum pump or water hose in the sweeping gas. These mixed configurations aim to reduce the vapour pressure at the permeate side, in order to thereby increase the driving force of the MD process.

For example, the TSGMD system consists in a modification being made to sweeping gas membrane distillation (SGMD), wherein the air that sweeps the permeate side is thermostated inside the module, placing a metal plate through which the coolant (liquid or gas) circulates. As such, the temperature of the permeate side is kept more constant and near to 25° C. This thereby means that the driving force of the process, i.e. the difference in concentration between both sides of the membrane, is the same as in the air gap membrane distillation configuration (AGMD) and as such, is kept more uniform through the module, reducing energy loss in the system.

In a preferred embodiment of step (c) and/or step (d), turbulence promoters are used in MD in order to increase the efficiency of the MD process, for example helixes in the chambers of the feed and permeate modules, modification of the membrane separators and supports themselves, modification of the walls of the membrane modules, or any mechanism for increasing the Reynolds number of the fluids that circulate tangentially to the membrane.

In the present invention method, the membranes used in MD are porous and hydrophobic, preferably being microporous. The use of these porous hydrophobic membranes in these membrane distillation techniques enables water vapour to pass through them and consumes low amounts of energy in comparison to conventional evaporation/crystallisation techniques, since the operating temperatures of the same are lower (below the boiling point of the aqueous stream to be treated). The membranes used in these membrane techniques can work with residual heat. Furthermore, MD works at atmospheric pressure, its driving force being the difference in vapour pressures of the streams at each side of the membrane, owing to a temperature difference.

The membranes used in the present invention may be manufactured from hydrophobic material such as polytetrafluoroethylene (PTFE), polypropylene (PP), polyvinylidene fluoride co-hexafluoride polypropylene (PVDF-HFPP) or any other hydrophobic material such as fluorinated polyoxadiazoles (FPOD) or fluorinated polyoxadiazoles (FPOT) or any combination thereof.

In a preferred embodiment, the polymeric membranes have the following characteristics:
High liquid entry pressure (LEP), over 2.7 kPa;
Good thermal stability;
High chemical resistance to solutions;
High permeability, taking into account that the permeate flux increases with: (1) increase in pore size (≦1 μm); (2) increase in porosity (up to 90%); (3) reduced thickness (up to 50 μm of active layer (without support)) and (4) a low tortuosity of the membrane (the lowest possible is 1);
Narrow pore size distribution and;
Low thermal conductivity.

In a preferred embodiment, the hydrophobic membrane of step (c) or step (d) has an average pore size of between 100 nm and 1 μm. This is more preferably between 120 nm and 600 nm.

The invention method produces pure water and reduces the volume of brines with the aim of reaching“zero-liquid discharge”. In the present invention, “pure water” is understood to mean a stream of high quality water, containing H₂O and H⁺ ions and OH⁻ in balance, as well as low electrical conductivity (<3-5 μS/cm at 25° C.).

Throughout the description and claims, the word “comprises” and variants thereof do not seek to exclude other technical characteristics, additions, components or stages. For those skilled in the art, other aims, advantages and characteristics of the invention may be derived, partly from the description and partly from putting the invention into practice. The examples and figures below are provided by way of illustration and by no means limit the present invention.

### BRIEF DESCRIPTION OF THE DRAWINGS

FIG. 1. shows the variation of the permeate flux with time for the DCMD configuration using brine treated with BaCl₂. Working temperatures of 75-25° C. MEM1.

FIG. 2. Is a schematic representation of the thermostatic sweeping gas membrane distillation device (TSGMD).

FIG. 3. Is a schematic representation of the combined hybrid system; chemical treatment+classical MD configuration+mixed MD configuration.

### EXAMPLES

The following membranes were used in the examples:

Membrane 1 (MEM1): thickness of 55 μm, average pore size of 199 nm, 69% porosity, a water entry pressure of 276 kPa and a high hydrophobicity with a water contact angle of 114°.

Membrane 2 (MEM2): thickness of 60 μm, average pore size of 418 nm, 64% porosity and a water entry pressure of 149 kPa and a high hydrophobicity with a water contact angle of 118° C.

Both membranes are flat in shape and are fabricated with mixtures of polytetrafluoroethylene (PTFE) and polypropylene (PP).

### Example 1

### A Method Using Direct Contact Membrane Distillation (DCMD)

The following examples begin with an aqueous saline stream of saline effluents coming from desalination plants (brines), containing 66.7±2.7 g/L of total dissolved solids (TDS), with an electrical conductivity of 74.7±1.8 mS/cm at 25° C. Table 1 shows the main salts contained in the saline stream, used in the examples studied.

TABLE 1
Analysis of the results of the aqueous saline stream used in the
examples:

| Variable | Value |
|---|---|
| pH | 7.9 ± 0.1 |
| Calcium (mgCa²⁺/L) | 960 ± 40 |
| Magnesium (mgMg²⁺/L) | 2.090 ± 80 |
| Sodium (mgNa⁺/L) | 16.200 ± 458 |
| Clorides (mgCl⁻/L) | 28.600 ± 1500 |
| Sulphates (mgSO₄²⁻/L) | 4.500 ± 200 |
| Alkalinity (mg CaCO₃/L) | 465 ± 25 |

A series of chemical treatments was applied to the start stream and, after that was concentrated by means of MD, in this particular example by means of DCMD.

### Example 1.1

A method with the DCMD system using the membrane MEM1 and CT1 (Chemical treatment 1) as a chemical treatment.

0.4 g/L of NaOH and 1.9 g/L of Na₂CO₃ were added to CT1 at room temperature (around 22° C.), during a reaction time of 15-30 minutes under stirring.

A precipitate was formed, which was separated by means of filtration following decantation.

The aqueous stream separated from the precipitate was passed to the DCMD system under the following conditions: a feed temperature of 75° C. and a permeate temperature of 25° C. It must be noted that the working temperature used in all the technical viability experiments on the MD process is 75° C. for the feed. The result obtained is shown in Table 2.

The initial permeate flux through the MEM1 was in the order of 54.36 kg/m²h. The feed concentration, obtained from the electrical conductivity measurements, increased from 67.37 g/L (initial concentration) to values greater than 375.38 g/L. The maximum TDS concentration increased significantly with the brine treated with NaOH and Na₂CO₃ in comparison to that obtained in the same working conditions for DCMD with non-treated brine (187.43 g/L). The concentration factor (p) has been defined as:

$$β = ( \frac{{C}_{f}}{{C}_{i}} ) \qquad ( 6 )$$

where Cᵢ and C_{f} are concentrations of the feed at initial and final time of the experiment, respectively. Since the duration of the experiments depends on various factors, with the aim of comparing the different experiments, a normalised concentration factor βₙ was defined, which is calculated based on the concentration factor obtained at 10 hours of operation, i.e.:

$${β}_{n} = ( \frac{β}{t} ) \times 10 \qquad ( 7 )$$

where t is the time the experiment lasts in hours. The normalised concentration factor at 10 hours (β₁₀) of the treated brine (TQ1) is 4.96, in comparison to 3.55 for DCMD with non-treated brine.

The electrical conductivity values of the permeate remain below 150 μS/cm during the first 9.5 hours, with an average value in this period of 19.93 μS/cm.

### Example 1.2

A method with the DCMD system, using membranes MEM1 and MEM2 and CT2 (Chemical treatment 2) as a chemical treatment.

In this case, the treatment (CT2) is carried out by increasing the temperature of the initial aqueous saline stream treated with NaOH and Na₂CO₃ at 75° C. before filtration, in order to successfully precipitate a greater amount of calcium carbonate and thus prevent formation of this crystalline phase in the DCMD system.

0.4 g/L of NaOH and 1.9 g/L of Na₂CO₃ are added to CT2, at a temperature of 75° C., during a reaction time of 15-30 min under stirring. A precipitate is formed, which is separated with filtration after decantation.

The aqueous stream separated from the precipitate was passed to the DCMD system under the following conditions (feed temperature at 75° C. and permeate temperature at 25° C.). The feed flow rate was 37.5±2.5 L/h and that of the permeate was 32.5±2.5 L/h.

During the experiment, solids in suspension did not appear in the feed circuit, which did indeed appear when the brine was used with NaOH+Na₂CO₃ treatment at room temperature (CT1). The result obtained is shown in Table 2.

The initial permeate flux through MEM1 was of the order of 52.33 kg/m²h. The permeability of the membrane reduces over operation time, until it reaches values of the order of 17.53 kg/m²h after 14 hours of operation. At the end of the experiment, a brine concentration in the order of 353.9 g/L was obtained. The electrical conductivity values of the permeate remained below 300 μS/cm during the first 12 hours.

In the experiments carried out in membrane 2 (MEM2), a slight reduction in the permeate flux was observed, from 74.34 kg/m²h to 56.14 kg/m²h after 6 hours operating time. The concentration of the feed increased from 65.55 g/L to values greater than 324 g/L. The normalised concentration factor (β₁₀) of the treated brine is 8.26. The electrical conductivity values of the permeate were observed to remain below 500 μS/cm over the first 5 hours.

The results of the experiments carried out show the importance of the caustic soda and sodium carbonate treatment at a high temperature. This result confirms that the treatment at room temperature does not remove completely the CaCO₃ or the calcium ions and carbonates present in the brine.

### Example 1.3

A method with the DCMD system using membrane MEM1 and CT3 (Chemical treatment 3) as a chemical treatment.

1.9 g/L of Na₂CO₃ was added to CT3 stream at a temperature of 75° C., over a reaction time of 15-30 minutes under stirring. A precipitate was formed, which was separated by means of filtration following decantation.

The stream separated from the precipitate was passed to the DCMD system under the following conditions: a feed temperature of 75° and a permeate temperature of 25° C. It must be noted that the working temperature employed in all the technical viability experiments on the membrane distillation process was 75° C. for the feed. The feed flow ratewas 37.5±2.5 L/h and that of the permeate was 32.5±2.5 L/h. The result obtained is shown in Table 2.

The experiments carried out using membrane 1 (MEM1) showed a reduced permeate flux via the membrane along the length of the operation time (59.68 kg/m²h in comparison to 23.01 kg/m²/h after 9 hours of operation). With this treatment, it is possible to concentrate the brine from 62.06 g/L to 278.30 g/L, thus obtaining a normalised concentration factor (β₁₀) of 4.96. Nevertheless, the electrical conductivity of the permeate increased rapidly from 8 hours, thus indicating the deterioration of the membrane characteristics.

### Example 1.4

A method with the DCMD system using membrane MEM1 and CT4 (Chemical treatment 4) as a chemical treatment.

The results obtained with previous treatments seem to indicate that the crystalline phase that most influences the brine concentration process is calcium sulphate and, as such, it is necessary to apply methods aiming to previously eliminate this crystalline phase.

It is possible to reduce the sulphate content by supplying excess calcium in order to form gypsum and/or by adding barium salts. The example indicated below shows the advantages of the brine treatment using barium salts, since this method is highly effective and facilitates the almost complete removal of all sulphates. The experiment shown was carried out with Membrane 1 in order to be able to compare the results of different chemical treatments.

In CT4, 9.7 g/L of BaCl₂ was added at room temperature during a reaction time of 20-49 minutes under stirring. A precipitate was formed, which was separated by means of filtration following decantation.

The stream separated from the precipitate was passed to the DCMD system under the following conditions: a feed temperature of 75° C. and a permeate temperature of 25° C.

The feed flow rate was 37.5±2.5 L/h and that of the permeate was 32.5±2.5 L/h. The result obtained is shown in Table 2.

The initial permeate flux through the membrane is of the order of 65.24 kg/m²h. After 6 hours of operation, the permeate flux fell by just 20% of the initial value (52.34 kg/m²h at 6 hours of operation).

The concentration of the feed increased from 65.73 g/L to 349.3 g/L during a total of 6 hours. However, it is possible to confirm that the vapour input pressure was exceeded in the membrane pores, which gave rise to increased conductivity of the permeate, due to salts passing through the pores. As such, it is possible to fix the effective duration of the experiment at 5 hours, reaching a value of β₁₀ with the brine treated (CT4) of 7.62.

Table 2 shows the influence of the chemical treatments on the performance of the brine concentration process, with direct contact membrane distillation (DCMD) at the working temperatures described above, in terms of permeate flux and the maximum concentration of TDS, C, attained in the feed, the maximum electrical conductivity of the feed, Ω, the concentration factor, p, and the normalised concentration factor, β₁₀.

TABLE 2
An overview of the values obtained in the various DCMD experiments,
with and without different chemical treatments (CT).

| | Membrane | | | | | | |
|---|---|---|---|---|---|---|---|
| | MEM1 | | | | | MEM2 | |
| Chemical treatment | NO CT | CT1 | CT2 | CT3 | CT4 | NO CT | CT2 |
| Average permeate flux | 40.68 | 43.17 | 38.46 | 45.83 | 61.95 | 34.87 | 69.29 |
| (kg/m²h) | | | | | | | |
| C maximum feed | 187.4 | 375.4 | 353.9 | 278.3 | 349.3 | 166.8 | 324.9 |
| (TDS, g/L) | | | | | | | |
| Ωmaximum feed | 152.5 | 224.5 | 218.1 | 192.5 | 216.7 | 141.4 | 208.9 |
| (mS/cm) | | | | | | | |
| β | 2.66 | 4.72 | 5.07 | 3.97 | 3.81 | 2.26 | 4.88 |
| β₁₀(in 10 h) | 3.55 | 4.96 | 3.62 | 4.96 | 7.62 | 2.82 | 8.26 |
| Experiment time(h) | 7.5 | 9.5 | 14 | 8 | 5 | 8 | 6 |

In order to be able to compare the permeate fluxes obtained with the different treatments, the fluxes were normalised relative to the values obtained with distilled water before the brine experiment. The normalised permeate flux Jₙ was defined as:

$${J}_{n} ( t ) = \frac{J brine treated ( t )}{J distilled water} \qquad ( 8 )$$

Similarly, small variations were observed in the initial electrical conductivity of the brines. As such, in order to be able to better compare the different treatments, a normalised electrical conductivity Ωₙ was defined as:

$${Ω}_{n} ( t ) = \frac{Ω brine treated ( t )}{Ω ( t = 0 )} \qquad ( 9 )$$

Comparing the different treatments used in DCMD for membranes MEM1 and MEM2 in terms of the normalised permeate flux and the normalised electrical conductivity of the feed, it is possible to conclude that for a aqueous saline stream with characteristics “similar” to those presented in this invention, the most effective chemical treatment for MEM1 is CT4, i.e. the brine treated with BaCl₂. In the present invention, “similar” is understood to mean saline effluents coming from desalination plants, which contain a TDS concentration greater than 40 g/L, with an electrical conductivity over 60 mS/cm. The highest normalised concentration factor β₁₀, of 7.62, was obtained in the brine treated with BaCl₂, as well as the reduction in the permeate flux was less significant (less than 20%). It must be noted that in the brines coming from desalination plants, the concentration of SO₄²⁻ is much higher than the concentration of types of carbon, thus meaning it is possible to conclude that the most effective treatment is that which facilitates the removal of permanent calcium hardness. CT2 (with NaOH and Na₂CO₃ at 75° C.) is a suitable treatment, since it concentrates the brine above the maximum concentration allowed in a water solution (353.9 g/L for MEM1) but at less permeate flux than that obtained with CT4, which may influence the processing time.

Using treatment CT1, the results for membrane MEM1 are very similar to those obtained with treatment CT2. For membrane MEM2, it is possible to conclude that treatment CT2 proved fairly effective.

### Example 2

### Estimation of the Useful Life of MEM1

Starting with the same stream as that used in example 1, i.e. with an aqueous saline stream of saline effluents coming from desalination plants, containing 66.7±2.7 g/L of total dissolved solids (TDS), with an electrical conductivity of 74.7±1.8 mS/cm at 25° C., Table 1 shows the main salts contained in the saline stream used in these examples.

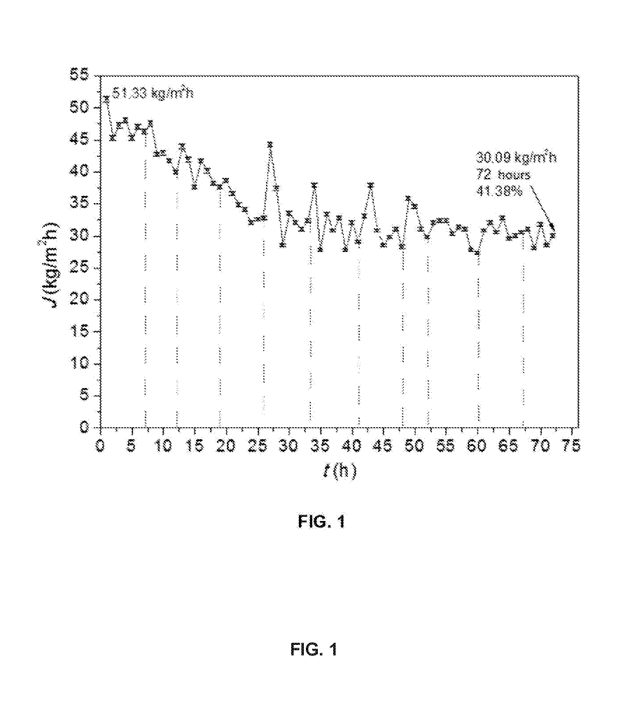

A long-term experiment was carried out in DCMD with membrane MEM1 and brine treated with BaCl₂(CT4 described in example 1.4) in order to estimate the useful life of the membrane. A treated stream brine which contains 65±3 g/L of total dissolved solids (TDS) and an electrical conductivity of 74.8±1.8 mS/cm at 25° C. was used. In order to estimate the useful life, the replacement of the permeate volume in each measurement of an hour is considered and the feed tank is filled with treated brine, at the concentration of 65 g/L, i.e. less than the concentration of brine retained in the feed. The idea is to assess whether or not it is possible to have a continuously functioning DCMD system, with brine from a desalination plant. It was observed that the useful life of the membrane is extended, producing constant permeate fluxes. In FIG. 1, it is possible to observe the permeate flux as a function of the operation time. The dotted lines represent the measurement days.

As can be seen in FIG. 1, the permeate flux begins at 51.33 kg/m²h and gradually decreases over a period of approximately 24 hours, from this moment, it becomes more or less constant at around 30 kg/m²h.

The concentration of the feed increases from 66.8±3.2 g/L TDS to 277.0±3.2 g/L TDS over the 72 effective hours considered in the experiment. Please note that the feed concentration value at 72 hours exceeds the saturation concentration of NaCl at 75° C. (273.90 g/L). The electrical conductivity of the permeate is kept at less than 2 mS/cm during the 72 hours, the equivalent approximate to 2.5 g/L of TDS.

### Example 3

### A Method Using Thermostatic Sweeping Gas Membrane Distillation (TSGMD)

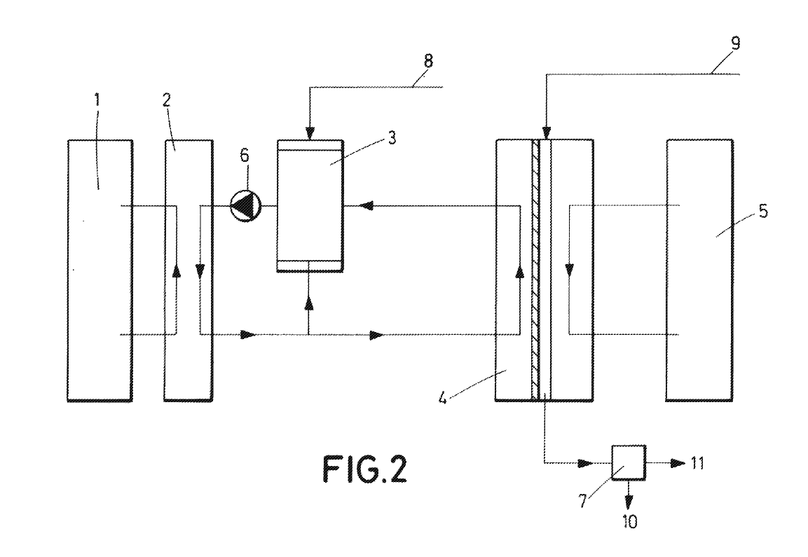

FIG. 2 is a schematic representation of the thermostatic sweeping gas membrane distillation device (TSGMD). The hybrid system consists of a modification made to the thermostatic sweeping gas membrane distillation system (TSGMD) wherein the gas that sweeps at the permeate side (9, 11) is thermostated inside the membrane module (4), placing a metal plate through which the coolant (liquid or gas) circulates, having been cooled by the coolant system (5). As such, the temperature of the permeate side is maintained mostly constant along the length of the module and as a consequence, makes it possible to successfully maintain and increase the driving force of the process, i.e. means that the difference in vapour pressure on both sides of the membrane are kept more constant through the membrane module length. According to the proposed configuration, the brine or saline effluent (8) located in the container (3) is circulated through the membrane module (4) by means of a circulation pump (6). The brine is previously heated to the operative temperature of the MD by means of a heat exchanger (2) and a heat source (1). The permeate (10) is condensed at 25° C. in the heat exchangers outside the module (7).

According to the configuration proposed, the cold plate that regulates the temperature of the permeate inside the membrane module must be made of a material with a high thermal conductivity capacity and/or a design that generates micro-turbulence, in order to improve heat transfer from the coolant to the permeate.

### Example 3.1

### A Hybrid System Using Thermostatic Sweeping Gas Membrane Distillation (TSGMD) and CT2 as a Chemical Treatment

Beginning with the same stream as in example 1, i.e. with an aqueous saline stream of saline effluents coming from desalination plants, containing 66.7±2.7 g/L of total dissolved solids (TDS) and an electrical conductivity of 74.7±1.8 mS/cm at 25° C. Table 1 showed the main salts contained in the saline stream used in these examples.

0.4 g/L of NaOH and 1.9 g/L of Na₂CO₃ were added to the previous stream in CT2, for a reaction time of 15-30 minutes under stirring. A precipitate formed, which was separated by means of filtration following decantation.

The aqueous saline stream treated with CT2 contains 63.5±3.2 g/L of total dissolved solids (TDS) and has an electrical conductivity of 72.5±2.8 mS/cm at 25° C. The stream separated from the precipitate was moved to the DCMD system under the following conditions: a feed temperature of 75° C., the temperature of the metal plate on the permeate side was 25° C. The feed flow rate was 100 L/h, whilst the air flow rate was kept constant at 25.1±1 L/minute, which gives rise to velocities of 0.07 and 1.10 m/s within the membrane module, for the feed and air, respectively. The result obtained is shown in Table 3.

Under optimal operation conditions, the permeate flux through MEM1 begins at an initial value of 33.92 kg/m²/h and decreases to 28.9 in 11 hours, until it reaches a final value of 24.12 kg/m²/h.

The feed concentration increased from 63.5 g/L TDS to a value close to 300 g/L in 11 hours of operating time, the value of β₁₀ was 4.24. The electrical conductivity of the permeate was kept at very low values throughout the entire duration, until it is clear that the pores of the membrane have been “wet” at 16 hours, reflected in an increase in the electrical conductivity of the permeate up to 1 mS/cm at 25° C.

The permeate flux through MEM2 begins at 37.5 kg/m²/h in the first hour and gradually reduces until it reaches the minimum (16.02 kg/m²h) after 10 hours of operation (a 57% decrease relative to the initial).

Under optimal conditions, the concentration in TDS of the feed rises to 250.3 g/L after 10 hours of work. The normalised concentration factor, β₁₀, is 3.76. The electrical conductivity of the permeate is kept at acceptable values until 10 hours, with an average of 112.40 μS/cm. At 11 hours, the pores of the membrane are “wet” and the electrical conductivity of the permeate rises increased above 600 μS/cm.

### Example 3.2

### A Method Using Thermostatic Sweeping Gas Membrane Distillation (TSGMD) and CT4 as a Chemical Treatment

Beginning with the same aqueous stream for the previous examples and for CT4, 9.7 g/L of BaCl₂ was added at room temperature, for a reaction time of 20-40 minutes under stirring. A precipitate was formed, which was separated by means of filtration following decantation.

Starting with an aqueous saline stream treated with CT4, containing 60.9±2.5 g/L of total dissolved solids (TDS) and an electrical conductivity of 70.5±0.8 mS/cm at 25° C., the stream separated from the precipitate was passed to the DCMD system under the following conditions: a feed temperature of 75° C., the temperature of the metal plate on the permeate side was 25° C. The feed flow rate is 100 L/h, whilst the air flow rate is kept constant at 25.1±1 L/min, which gives rise to velocities of 0.07 and 1.10 m/s inside the membrane module, for the feed and air, respectively. The obtained result is shown in Table 3.

Another way to treat the saline effluents consists of removing the sulphate ions rather than removing the calcium, providing carbonic species, whilst increasing the alkalinity of the system. One of the most efficient methods for achieving this aim consists of adding barium salts in order to form barite (a crystalline phase that is very poorly soluble). The experiments carried out with MEM2 showed a 39.84% decrease in the permeate flux, relative to the initial value (33.28 kg/m²h) after 11 hours of operation.

The electrical conductivity of the feed increases to 262 g/L during a total of 11 hours. However, at 6 hours operation time, the electrical conductivity of the permeate begins to increase, damaging the membrane characteristics. A period of 10 hours was used as the effective duration of the experiment, the value of β₁₀ being 3.77. It must be noted that different experiments were carried out using treated brine (CT4) at different pH values. The obtained results showed that pH does not influence significantly the performance of the brine concentration process under optimal operative conditions.

A study was carried out on the average half-life of the membranes and and their aging. The effect of continuously adding brine to the feed and having to clean the membranes was also studied. As such, a long-term experiment was carried out, consisting of continuously adding an amount of brine treated with BaCl₂ equal to the amount of permeate obtained. The system developed made it possible to obtain an average permeate flux of 28 kg/m²h during the first 26 hours of operation, thus obtaining a concentrated feed of the order of 194.5 g/L TDS. As of this moment, a decrease in the permeate flux was observed, due to the increase of the concentration of the brine. Subsequently, after 31 hours of operation, the quality of the permeate changed due to the feed solution filtering through the pores, thus increasing the conductivity of the permeate Subsequently an effective assay duration time of 31 hours was determined. It is recommended that an end salinity level of 190 g/L TDS is not exceeded. In optimal conditions, this concentration may be obtained after 26 hours' of operation time.

Upon increasing the salinity of the feed, the permeate flow is reduced and the vapour input pressure into the membrane pores is exceeded, thus reducing the output of the process significantly and compromising the quality of the permeate.

### Example 3.3

### A Method Using Thermostatic Sweeping Gas Membrane Distillation (TSGMD) and CT5 as a Chemical Treatment

We began with the same aqueous stream described in the previous examples was used. 0.4 g/L of NaOH and 1.9 g/L of Na₂CO₃ were added for CT5, at a temperature of 75° C., for a reaction time of 15-30 minutes under stirring. A precipitate was formed, which was separated by means of filtration following decanting. 9.7 g/L of BaCl₂ was subsequently added at room temperature, for a reaction time of 20-40 minutes under stirring. A precipitate was formed, which was separated by means of filtration following decantation.

Beginning with a aqueous saline stream treated with CT5, containing 56.2±2.2 g/L of total dissolved solids (TDS) and an electrical conductivity of 67.1±1.4 mS/cm at 25° C., the current separated from the precipitate was passed to the TSGMD system under the following conditions: a feed temperature of 75° C., the temperature of the metal plate on the permeate side being 25° C. The feed flow rate is 100 L/h, whilst the air flow is kept constant at 25.1±1 l/min, which gives rise to respective feed and air flow velocities within the membrane module of 0.07 and 1.10 m/s, respectively.

During all the experiment, the permeate flux remained more or less stable, only going down by 15.21% relative to the initial value (35.46 kg/m²h). This may be explained by the absence of solutes, which tend to precipitate throughout the duration of the brine concentration process, thus reducing the membrane “contamination” thereof.

The concentration of the feed increased from 56.2 g/L TDS to 275.13 g/L at 9.5 hours of operation, the value of β₁₀ was 5.15. The electrical conductivity of the permeate was kept at acceptable values.

Table 3 compares the results obtained with the membrane distillation systems (TSGMD and AGMD) using the very treatments described above and without treatment. The parameters taken into account were permeate flux, maximum TDS concentration attained in the feed stream, C, maximum feed electrical conductivity, Ω, concentration factor, β, and normalised concentration factor (β₁₀).

The conditions under which AGMD experiments were carried out are similar to those carried out in TSGMD ones. The feed flow rate was 100 L/h. The feed temperature was 75° C. and the temperature of the metal plate where the vapour is condensed in the module was 25° C.

The TSGMD and AGMD experiments without treatment were carried out with the same aqueous saline stream described in example 1.

TABLE 3
A summary of the results obtained for the various experiments using AGMD and TSGMD.

| | Membrane | | | | | | |
|---|---|---|---|---|---|---|---|
| | MEM1 | | | MEM2 | | | |
| Chemical treatment | AGMD No CT | TSGMD No CT | TSGMD CT2 | TSGMD No CT | TSGMD G CT2 | TSGMD G CT4 | TSGMD CT5 |
| Average permeate flux | 24.22 | 28.64 | 31.35 | 26.13 | 31.00 | 29.93 | 33.86 |
| (kg/m²h) | | | | | | | |
| C maximum feed | 175.5 | 163.6 | 296.03 | 158.90 | 250.3 | 261.98 | 275.13 |
| (TDS, g/L) | | | | | | | |
| Ω maximum feed | 146.2 | 139.6 | 199.0 | 136.9 | 181.5 | 186.2 | 191.3 |
| (mS/cm) | | | | | | | |
| β | 2.87 | 2.80 | 4.66 | 2.13 | 3.76 | 3.77 | 4.89 |
| β₁₀ (in 10 h) | 2.61 | 3.11 | 4.24 | 2.66 | 3.76 | 3.77 | 5.15 |
| Experiment time (h) | 11 | 9 | 11 | 8 | 10 | 10 | 9.5 |

Taking into account the obtained results for the TSGMD configuration using different treatments, it is possible to assert that treatment with NaOH and Na₂CO₃ at 75° C. is more effective in this TSGMD configuration than the experiment without treatment. As can be seen in Table 3, the best results correspond to the TSGMD configuration with treatment CT2, managing to concentrate the brine at values over 296 g/L for membrane MEM1 and 250 g/L for membrane MEM2.

In order to better compare the results, the normalised permeate flux and normalised electrical conductivity were calculated for the feed for the different membranes in the TSGMD configuration with and without treatment (CT). In view of the normalised values, it is possible to conclude that for the TSGMD configuration using MEM2, the best treatment is CT5, i.e. using NaOH+Na₂CO₃+BaCl₂. Nevertheless, for the type of stream from which we begin, it may not be necessary to use NaOH to obtain these results, if you take into account the conclusions derived from the DCMD configuration.

In the case of MEM1, a slight improvement was observed with chemical treatment CT2, in comparison to the untreated brine. The normalised permeate flux with the treated brine is greater and is kept practically constant for a longer period of time than the untreated brine.

### Example 4

### A Combined Hybrid System: Chemical Treatment+DCMD+TSGMD

Below, a proposal for a combined hybrid system for concentrating and purifying brine coming from desalination plants is set out, with the aim of achieving “zero-liquid discharge”. One configuration of this combined hybrid system is formed by a brine treatment plus a conventional membrane distillation system (for example DCMD) and another mixed membrane distillation system (such as TSGMD). According to the characteristics of the water to be treated, it is possible to choose the most suitable treatment method. This system is not limited to simply using flat membranes (MEM1 and MEM2) either. Rather, other types of porous and hydrophobic membranes with different structures and hollow fibers, etc., may also be used. It is by no means limited to any kind of temperature range, it being capable of working at different pH values. Finally, it is not limited to use with brine coming from reverse osmosis plants.

In this most preferred—TSGMD—configuration, the operating conditions are essentially the same as in the previous TSGMD examples. In the present invention, the word “essentially” is understood to mean that the temperatures may differ between ±10° C. (permeate) and 25° C. (feed) and the feed flow rate may differ by ±100 L/h, whilst the air flow may differ by ±25 L/min.

In the most preferred—DCMD—configuration, the operating conditions are essentially the same as in the previous DCMD examples. In the present invention, the word “essentially” is understood to mean that temperatures may differ between ±10° C. (permeate) and 25° C. (feed) and the feed flow rate and permeate flow rate may differ in an interval from 25 L/h to 200 L/h.

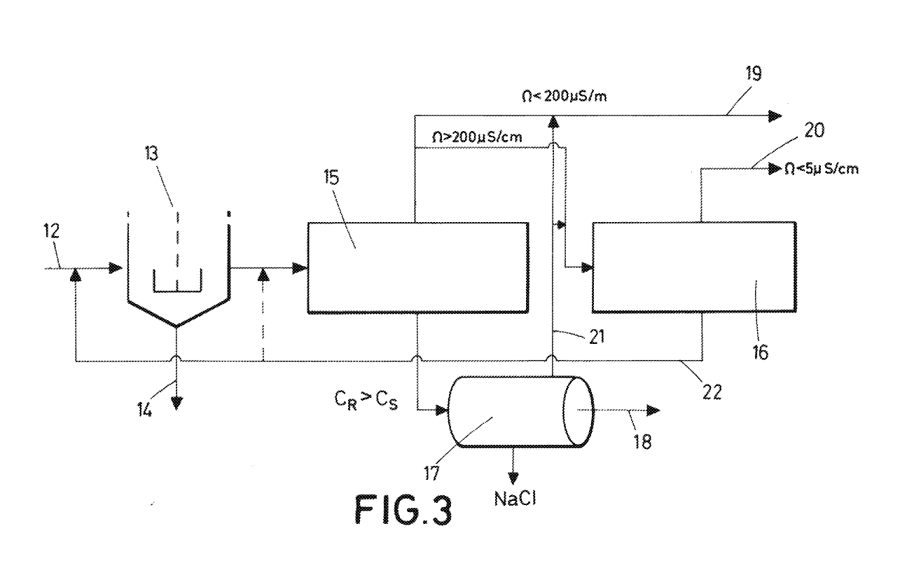

In this example, the operational parameters of the new system proposed are presented (FIG. 3):

The brine or saline effluent (12) is subjected to one of the chemical treatments described in the present invention (13), using the following as reactants: sodium hydroxide NaOH, sodium carbonate Na₂CO₃, calcium hydroxide Ca(OH)₂, calcium chloride CaCl₂, barium chloride BaCl₂ or any other chemical reactant needed or combinations thereof, depending on the initial effluent (12).

The salts formed in the treatment (14) (essentially salts such as: calcium carbonate CaCO₃, barium carbonate BaCO₃, strontium carbonate SrCO₃, magnesium carbonate MgCO₃, a mixture of calcium and magnesium carbonate CaₓMg₁₋ₓCO₃, calcium phosphate Ca₃(PO₄)₂, calcium fluoride CaF₂, magnesium hydroxide Mg(OH)₂, calcium sulphate CaSO₄ at different levels of hydration and silica) are separated by means of filtration and/or decantation.

The saline stream subsequently circulates around a simple or “classic” membrane distillation (15) system, for example a DCMD, SGMD, AGMD or VMD system, using an hydrophobic and microporous membrane with an pore size lower than 250 nm (for example MEM1 from the previous examples, which makes it possible to attain greater concentrations and has an acceptable useful life). When the concentration of the feed exceeds limiting salt saturation concentration (C_{R}>C_{S}), the brine passes through a crystalliser (17), where the salts susceptible to precipitation are recovered. It is possible to recover salts with high added value from the remaining effluent. During this thermal concentration process, product water (21) is obtained, which may be mixed with the permeate of the first MD step.

Given that the quality of the permeate (19) reduces with time, a proposal has been made to treat the permeate of the first MD step with a mixed membrane distillation configuration (16) (for example TSGMD or LGMD), with a microporous hydrophobic membrane with a pore size over 250 nm, for example with MEM2 in the examples above. It is thus possible to produce high quality water (20) (with an electrical conductivity less than 5 μS/cm at 25° C.) and a concentrate (22), which may be sent to the reaction chamber (13) or the first MD step (15).

When the retentate concentration (C_{R}) in the system (16), for example a TSGMD system, is close to 50-60% of the concentration saturation (C_{S}), it may re-circulate around the system (15), for example a DCMD system. This mixed configuration would attain “zero-liquid discharge”.

1. A method for treating aqueous saline streams, comprising the following steps:
a. Applying a chemical treatment to the saline stream at a temperature above the freezing point of the aqueous stream to be treated, up to the temperature at which step (c) is carried out, in order to remove permanent calcium hardness, temporary calcium hardness and/or to reduce or remove sulphates, until a calcium and magnesium concentration of less than 3 ppm is obtained and a sulphate concentration of less than 1 g/L is obtained;
b. Separating the salts formed in step (a) and;
c. Concentrating the aqueous stream obtained in the separation step (b) by means of membrane distillation at a temperature below the boiling point of said aqueous stream, where the membrane is a porous, hydrophobic polymeric membrane.

2. The method according to claim 1, where the temperature of step (a) is essentially the same as the temperature of step (c).

3. The method according to any of the claim 1 or 2, where the temperature of step (a) and/or (c) is between 18 and 85° C. and more preferably, between 25 and 75° C.

4. The method according to any of the claims 1 to 3, where the pressure of steps (a) and/or (c) is atmospheric pressure.

5. The method according to any of the claims 1 to 4, where the membrane distillation type is selected from direct contact membrane distillation (DCMD), sweeping gas membrane distillation (SGMD), air gap membrane distillation (AGMD), vacuum membrane distillation (VMD) or any other mixed MD configuration, such as thermostatic sweeping gas membrane distillation (TSGMD), liquid gap membrane distillation (LGMD) or another mixed MD configuration.

6. The method according to any of the claims 1 to 5, where it furthermore comprises a purification step (d) for purifying the aqueous stream obtained in step (c), by means of membrane distillation at a temperature below the boiling point of said aqueous stream to be purified, where the membrane is a porous, hydrophobic polymeric membrane.

7. The method according to claim 6, where the temperature of step (d) is essentially the same as the temperature of step (a).

8. The method according to any of the claim 6 or 7, where the temperature of step (d) is between 18 and 85° C. and more preferably between 25 and 75° C.

9. The method according to any of the claims 6 to 8, where the pressure of step (d) is atmospheric pressure.

10. The method according to any of the claims 6 to 9, where the membrane distillation of step (d) is selected from direct contact membrane distillation (DCMD), sweeping gas membrane distillation (SGMD), air gap membrane distillation (AGMD), vacuum membrane distillation (VCMD), thermostatic sweeping gas membrane distillation (TSGMD), liquid gap membrane distillation (LGMD) or any mixed MD configuration.

11. The method according to any of the claims 1 to 10, where turbulence promoters are used in the membrane distillation of step (c) and/or (d).

12. The method according to any of the claims 1 to 11, where the hydrophobic membrane of step (c) or (d) has an average pore size of between 100 nm and 1 μm.

13. The method according to any of the claims 1 to 12, where the hydrophobic membrane of step (c) or (d) has an average pore size of between 120 nm and 600 nm.

14. The method according to any of the claims 1 to 13, where the hydrophobic membrane of step (c) or step (d) has a liquid entry pressure over 2.7 kPa.

15. The method according to any of the claims 1 to 14, where the membrane is made of at least polytetrafluoroethylene (PTFE), polyvinylidene fluoride (PVDF), polypropylene (PP), polyvinylidene fluoride co-hexafluorinated polyoxadiazoles (FPOD) fluoridic polyoxatriazoles (FPOT) or any combination thereof.

16. The method according to any of the claims 1 to 15, where step (c) is carried out by means of direct contact membrane distillation.

17. The method according to any of the claims 6 to 16, where step (d) is carried out by means of thermostatic sweeping gas membrane distillation or air gap membrane distillation.

18. The method according to any of the claims 1 to 17, where step (b) is carried out by means of decantation and/or filtration.

19. The method according to any of the claims 1 to 18, where sodium hydroxide, sodium carbonate or both are added in step (a), in order to remove temporary and permanent calcium hardness.

20. The method according to any of the claims 1 to 19, where calcium salts, selected from calcium chloride and/or lime, or barium salts selected from barium carbonate or barium chloride are added in step (a), in order to reduce or remove sulphates.

21. The method according to any of the claims 1 to 20, where sodium hydroxide, sodium carbonate and barium chloride are added to step (a), in order to remove permanent calcium hardness, temporary calcium hardness and to reduce or remove sulphates.

22. The method according to any of the claims 1 to 21, where the aqueous saline stream are saline effluents.

23. The method according to claim 22, where the saline effluent comes from desalination plants, with a total dissolved solids content of over 40 g/L and an electrical conductivity of over 60 mS/cm at 25° C., where the most abundant salt is NaCl, with a content of over 60% by weight relative to the total dissolved salts content.
